(19) United States
(12) Patent Application Publication
(10) Pub. No.: US 2022/0084354 A1
(43) Pub. Date: Mar. 17, 2022

(54) SPORTS-BASED WAGERING BOARD

(71) Applicant: Stephen J. Walker, Mandeville, LA (US)

(72) Inventor: Stephen J. Walker, Mandeville, LA (US)

(21) Appl. No.: 17/476,423

(22) Filed: Sep. 15, 2021

Related U.S. Application Data
(60) Provisional application No. 63/078,862, filed on Sep. 15, 2020.

(51) Int. Cl. G07F 17/32

(52) U.S. Cl. CPC G07F 17/3216; G07F 17/3288

(57) ABSTRACT

The sports-based wagering game includes a wagering board that facilitates betting on the outcome of normally-occurring events, having a random outcome, that occur during a predetermined sport on which the wagering board is based. An example sports-based wagering game includes: a wagering board associated with a predetermined sport, the wagering board including four columns, each of the four columns represents a separate category of play, each category of play is a set of normally-occurring events having a random outcome during the predetermined sport, the set of normally occurring events is represented on the wagering board as a separate section for each normally-occurring event, each of the separate sections include at least two opposing positions for wagered tokens to be placed; and a plurality of tokens representative of money being wagered.

### CROSS-REFERENCE TO RELATED APPLICATION

This application claims the benefit of U.S. Provisional Application Ser. No. 63/078,862, filed on Sep. 15, 2020, the entirety of which is incorporated herein by reference.

### TECHNICAL FIELD

This disclosure relates to implementations of a sports-based wagering board used to facilitate betting during a televised sporting event.

### BACKGROUND

People enjoy watching sporing events of all types, and wagering on the outcome of those sporting events. In addition, many people enjoy informal wagers between friends and home-based games.

Accordingly, it can be seen that needs exist for the sports-based wagering board disclosed herein. It is to the provision of a sports-based wagering board configured to address these needs, and others, that the present invention is primarily directed.

### SUMMARY OF THE INVENTION

Implementations of a sports-based wagering game are provided. The sports-based wagering game includes a wagering board that facilitates betting on the outcome of normally-occurring events, having a random outcome, that occur during a predetermined sport on which the wagering board is based.

An example sports-based wagering game includes: a wagering board associated with a predetermined sport, the wagering board including four columns, each of the four columns represents a separate category of play, each category of play is a set of normally-occurring events having a random outcome during the predetermined sport, the set of normally occurring events is represented on the wagering board as a separate section for each normally-occurring event, each of the separate sections include at least two opposing positions for wagered tokens to be placed; and a plurality of tokens representative of money being wagered.

Another example sports-based wagering game includes: a wagering board associated with a predetermined sport, the wagering board including a first column representing a first category of play, a second column representing a second category of play, a third column representing a third category of play, and a fourth column representing a fourth category of play; and a plurality of tokens representative of money being wagered. The first category of play is a first set of normally-occurring events having a random outcome during the predetermined sport, each normally-occurring event of the first set is represented on the wagering board as a separate section, each of the separate sections include two opposing positions for wagered tokens to be placed. The second category of play is a second set of normally-occurring events having a random outcome during the predetermined sport, each normally-occurring event of the second set is represented on the wagering board as a separate section, each of the separate sections include two opposing positions for wagered tokens to be placed. The third category of play is a third set of normally-occurring events having a random outcome during the predetermined sport, each normally-occurring event of the third set is represented on the wagering board as a separate section, each of the separate sections include two opposing positions for wagered tokens to be placed. The fourth category of play is a fourth set of normally-occurring events having a random outcome during the predetermined sport, each normally-occurring event of the fourth set is represented on the wagering board as a separate section, each of the separate sections include at least two opposing positions for wagered tokens to be placed.

In some implementations, the sports-based wagering game is governed by rules including: (i) a wager is made by placing one or more tokens on the section of the wagering board corresponding to the normally-occurring event two or more players are wagering on, and (ii) an equal number of tokens must be placed on each opposing position of the section for the normally-occurring event the two or more players are wagering on.

### BRIEF DESCRIPTION OF THE DRAWINGS

FIG. 1 illustrates a sports-based wagering board according to the principles of the present disclosure.

FIG. 2 illustrates example tokens used in conjunction with the sports-based wagering board shown in FIG. 1.

Like reference numerals refer to corresponding parts throughout the several views of the drawings.

### DETAILED DESCRIPTION

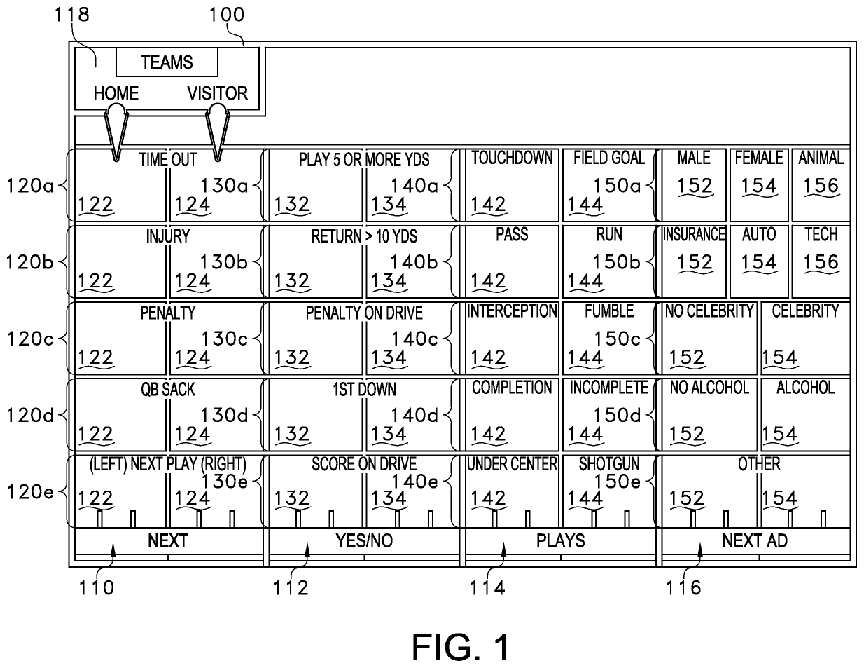

FIG. 1 illustrate an example sports-based wagering board 100 according to the principles of the present disclosure. The wagering board 100 facilitates betting on the outcome of normally-occurring events, having a random outcome, that occur during a predetermined sport on which the wagering board 100 is based.

As shown in FIG. 1, the exemplary implantation of the sports-based wagering board 100 is adapted for use while watching the sport of football (i.e., American football). The wagering board 100 will be used, or played, in conjunction with the viewing of all or a portion of a football game. The outcome of any bet, or wager, placed using the wagering board 100 will be determined by a normally-occurring event during the football game. While the sports-based wagering board 100 of the present disclosure is configured for use during a football game, the wagering board 100 could be adapted for use while viewing other sports (e.g., baseball, basketball, etc.).

FIG. 1 is a top view of an exemplary sports-based wagering board 100. The wagering board 100 includes four columns (110, 112, 114, 116), each column representing a separate category of play. Each category of play is made up of a set of normally-occurring events having a random outcome that players can wager on. While the preferred implementation of the wagering board 100 is made of foamboard, it is contemplated that, in some implementations, a wagering board 100 could be fabricated of another suitable material (e.g., paper board).

As shown in FIG. 1, under the heading “TEAMS” 118, indicia for “HOME” and “VISITOR” are positioned at the top of the first column 110. The first column 110 facilitates wagering on which team, “HOME” or “VISITOR”, will be responsible for the “NEXT” event described in each section (120a-120e) thereof. Each section of the first column 110 facilitates wagering on an upcoming normally-occurring event having a random outcome. In particular, the first column 110 includes sections that facilitate wagering on which team will have the next: “TIME OUT” (i.e., section 120a), “INJURY” (i.e., section 120b), “PENALTY” (i.e., section 120c), “QB SACK” (i.e., section 120d); and if the direction of play goes to the “LEFT” or “RIGHT” side of the field (i.e., section 120e). Each section (120a-120e) in the first column 110 includes two opposing positions (122, 124), or spaces, on the wagering board 100 for wagered tokens to be placed.

The second column 112 facilitates placing “YES” or “NO” wagers, the outcome of which is tied to an upcoming normally-occurring event having a random outcome. In particular, the second column 112 includes sections (130a-130e) that facilitate wagering on whether the next “PLAY” will result in a gain of 5 or more yards (i.e., section 130a), the “RETURN” being greater than 10 yards (i.e., section 130b), there being a “PENALTY” on the current drive (i.e., section 130c), a “1st DOWN” being accomplished on the current drive (i.e., section 130d), and there being a “SCORE” on the current drive (i.e., section 130e). As with the first column 110, each section (130a-130e) in the second column 112 includes two opposing positions (132, 134), or spaces, on the wagering board 100 for wagered tokens to be placed.

The third column 114 facilitates placing wagers on the outcome of upcoming “PLAYS” that normally occur during a football game. In particular, the third column 114 includes sections (140a-140e) that facilitate wagering on whether the next score is a “TOUCHDOWN” or “FIELD GOAL” (i.e., section 140a), if the next play is a “PASS” or “RUN” (i.e., section 140b), if the next turnover results from an “INTERCEPTION” or “FUMBLE” (i.e., section 140c), if the next pass attempt will be a “COMPLETION” or an “INCOMPLETE” (i.e., section 140d), and if the quarter back (QB) will take the next snap from an “UNDER CENTER” or a “SHOTGUN” position (i.e., section 140e). As with the first and second columns (110, 112), each section (140a-140e) in the third column 114 includes two opposing positions (142, 144), or spaces, on the wagering board 100 for wagered tokens to be placed.

The fourth column 116 facilitates placing wagers on advertisements that run during the football game, specifically features of an upcoming advertisement (i.e., the “NEXT AD”). In particular, the fourth column 116 includes sections (150a-150e) that facilitate wagering on a variety of advertisements. For example, in section 150a, wagers can be placed on whether an upcoming advertisement (or “ad”) will feature a “MALE” actor, a “FEMALE” actor, or an “ANIMAL” actor. As another example, in section 150b, wagers can be placed regarding the topic of the upcoming advertisement (e.g., insurance, automobile, technology). As yet another example, in section 150c, wagers can be placed on whether or not the upcoming advertisement features a “CELEBRITY”. As still yet another example, in section 150d, wagers can be placed on the type of beverage(s) presented in the upcoming advertisement (e.g., alcoholic, or non-alcoholic). In some implementations, the fourth column 116 of the wagering board 100 includes an “OTHER” section 150e used by players to setup a unique wager related to an upcoming advertisement. Each section (150a-150e) in the fourth column 116 includes two or three opposing positions (152, 154, 156), or spaces, on the wagering board 100 for wagered tokens to be placed.

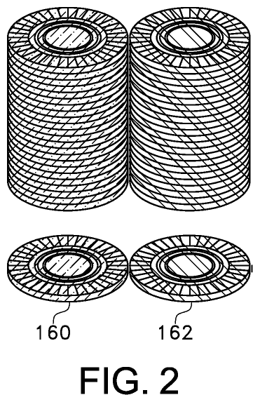

Example tokens (160, 162) used in conjunction with a wagering board 100 are shown in FIG. 2. However, tokens may vary in size, shape, and color. Tokens (e.g., 160, 162) are distributed to each player at the outset of the game. Tokens (e.g., 160, 162) can be wagered by players, and paid out to one or more players according to the outcome of a wager placed using the sports-based wagering board 100. If not prohibited by law, monetary value can be assigned to the tokens (e.g., 160, 162). In some implementations, the tokens may be poker chips (see, e.g., FIG. 2) or cash (e.g., nickels, quarters, and the like).

Game Play:

While viewing a football game, two or more players can wager on the outcome of any normally-occurring event listed in one of the columns 110, 112, 114, 116 of the sports-based wagering board 100. Wagers are made by placing tokens (e.g., 160, 162) on a section of the wagering board 100 corresponding to the normally-occurring event two or more players wish to wager on.

For a wager to be made, an opposing wager of equal value is required. Therefore, at least one token need be placed on each position (e.g., 122, 124) of the same section (e.g., 120a) of the wagering board 100. Should a particular section of the wagering board 100 have uneven opposition, the first two players to place tokens in opposing positions have secured the competition. A third player can wager on this section of the wagering board 100 if another player is willing to place an opposing wager. Once the outcome of the normally-occurring event wagered on is known, a winner is declared. The winner takes back their token(s) and any token(s) placed to oppose their wager.

As an example of game play, player one and player two want to wager on whether the current drive will result in a “1st DOWN”. Player one is willing to bet that the current drive will result in a 1st down and places a token 160 on the position 132 above “YES” in the appropriate section 130d of the second column 112 of the wagering board 100. Player two is willing to bet that the current drive will not result in a 1st down and places a token 162 on the position 134 above “NO”, found in the same section 130d of the second column 112. Once the normally-occurring event is complete (i.e., the current drive in this example), the winning player takes both tokens 160, 162.

Expanding on the above example, if a third player wants to wager on whether the current drive will result in a “1st DOWN”, one of the other players must be willing to place an opposing wager. Or, in other words, player one or player two must be willing to wager another token to counter a token placed by player three. If neither player is willing to place an additional wager, player three is prevented (or locked out) from wagering on that section of the wagering board 100 until completion of the normally-occurring event.

Should two or more players wager on a normally-occurring event that does not occur during the football game being viewed, each player gets their wagered token(s) back at the end of game play.

Game play with the sports-based wagering board 100 may continue during all or part of a predetermined sporting event.

If applicable, players can trade back tokens to each other before cashing out.

Reference throughout this specification to “an embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations are depicted in the drawings in a particular order, this should not be understood as requiring that such operations be performed in the particular order shown or in sequential order, or that all illustrated operations be performed, to achieve desirable results.

1. A sports-based wagering game comprising:
a wagering board associated with a predetermined sport, the wagering board including four columns, each of the four columns represents a separate category of play, each category of play is a set of normally-occurring events having a random outcome during the predetermined sport, the set of normally occurring events is represented on the wagering board as a separate section for each normally-occurring event, each of the separate sections include at least two opposing positions for wagered tokens to be placed; and
a plurality of tokens representative of money being wagered.

2. The sports-based wagering game of claim 1, wherein the game is governed by rules including: (i) a wager is made by placing one or more tokens on the section of the wagering board corresponding to the normally-occurring event two or more players are wagering on, (ii) an equal number of tokens must be placed on each opposing position of the section for the normally-occurring event the two or more players are wagering on.

3. The sports-based wagering game of claim 1, wherein the predetermined sport is football.

4. The sports-based wagering game of claim 1, wherein the tokens are poker chips.

5. A sports-based wagering game comprising:
a wagering board associated with a predetermined sport, the wagering board including a first column representing a first category of play, a second column representing a second category of play, a third column representing a third category of play, and a fourth column representing a fourth category of play; and
a plurality of tokens representative of money being wagered;
wherein the first category of play is a first set of normally-occurring events having a random outcome during the predetermined sport, each normally-occurring event of the first set is represented on the wagering board as a separate section, each of the separate sections include two opposing positions for wagered tokens to be placed;
wherein the second category of play is a second set of normally-occurring events having a random outcome during the predetermined sport, each normally-occurring event of the second set is represented on the wagering board as a separate section, each of the separate sections include two opposing positions for wagered tokens to be placed;
wherein the third category of play is a third set of normally-occurring events having a random outcome during the predetermined sport, each normally-occurring event of the third set is represented on the wagering board as a separate section, each of the separate sections include two opposing positions for wagered tokens to be placed;
wherein the fourth category of play is a fourth set of normally-occurring events having a random outcome during the predetermined sport, each normally-occurring event of the fourth set is represented on the wagering board as a separate section, each of the separate sections include at least two opposing positions for wagered tokens to be placed.

6. The sports-based wagering game of claim 5, wherein the game is governed by rules including: (i) a wager is made by placing one or more tokens on the section of the wagering board corresponding to the normally-occurring event two or more players are wagering on, (ii) an equal number of tokens must be placed on each opposing position of the section for the normally-occurring event the two or more players are wagering on.

7. The sports-based wagering game of claim 5, wherein the predetermined sport is football.

8. The sports-based wagering game of claim 5, wherein the tokens are poker chips.

9. The sports-based wagering game of claim 5, wherein the first column facilitates wagering on which team, “HOME” or “VISITOR”, will be responsible for the “NEXT” normally-occurring event of the first set described in the separate sections of the first column.

10. The sports-based wagering game of claim 5, wherein the second column facilitates “YES” or “NO” wagers tied to the outcome of the normally-occurring events of the second set described in the separate sections of the second column.

11. The sports-based wagering game of claim 5, wherein the third column facilitates wagering on an outcome for upcoming “PLAYS” that occur during the predetermined port.

12. The sports-based wagering game of claim 5, wherein the fourth column facilitates wagering on upcoming advertisements that run during the predetermined sport.
